(19) United States
(12) Patent Application Publication
(10) Pub. No.: US 2018/0136904 A1
(43) Pub. Date: May 17, 2018

(54) ELECTRONIC DEVICE AND METHOD FOR CONTROLLING ELECTRONIC DEVICE USING SPEECH RECOGNITION

(71) Applicant: SAMSUNG ELECTRONICS CO., LTD., Suwon-si (KR)

(72) Inventors: Kwang-Youn KIM, Seoul (KR); Won-Nam JANG, Suwon-si (KR); Soo-Yeon KIM, Seoul (KR); Su-Yeon HWANG, Anyang-si (KR)

(21) Appl. No.: 15/809,141

(22) Filed: Nov. 10, 2017

Related U.S. Application Data
(60) Provisional application No. 62/422,844, filed on Nov. 16, 2016.

(30) Foreign Application Priority Data
Feb. 20, 2017 (KR) 10-2017-0022396

(51) Int. Cl. G06F 3/16; G10L 15/26; G06F 17/21; G06F 3/0481; G06F 3/0482

(52) U.S. Cl. CPC G06F 3/167; G10L 15/265; G06F 3/0482; G06F 3/04817; G06F 17/214

(57) ABSTRACT

According to an embodiment of the present disclosure, an electronic device may comprise a microphone, a display, and a processor, wherein the processor may be configured to control the display to display, on the display, content including at least one object and at least one text corresponding to the at least one object, the at least one text obtained based on a resource comprising the content, to determine a first text from among the at least one text corresponding to a voice received using the microphone, and to execute a command corresponding to the received voice on a first object corresponding to the first text from among the at least one object based on at least one command registered to control the at least one object.

### CROSS-REFERENCE TO RELATED APPLICATIONS

This application is based on and claims priority under 35 U.S.C. § 119 to a U.S. provisional patent application filed in the United States Patent and Tradmark Office on Nov. 16, 2016 and assigned Ser. No. 62/422,844, and a Korean patent application filed in the Korean Intellectual Property Office on Feb. 20, 2017 and assigned Serial No. 10-2017-0022396, the disclosures of which are incorporated by reference herein in their entireties.

### TECHNICAL FIELD

The present disclosure relates generally to electronic devices and methods for controlling electronic devices using speech recognition.

### DISCUSSION OF RELATED ART

Conventional electronic devices require an additional input device, e.g., a mouse or a keyboard, a touch display or other hardware devices for controlling content displayed on the screen. For example, a user may conventionally choose his or her desired object from the content displayed on the screen of an electronic device and execute a particular function using an input device, e.g., a mouse. The user may also enter his or her desired text.

Recently, the development of technology enables the control of content on the screen using speech recognition. Speech recognition-based control techniques have been designed to enable an electronic device to recognize predetermined words spoken out in a voice to run an application or to enable voice control based on information separately prepared.

With no mouse, keyboard, or other input devices or under the environmental restriction, e.g., where the user is moving on the street, the conventional entry schemes would not work well when the user controls the content displayed on the screen of the electronic device.

Conventional speech recognition-based control of electronic devices requires preparing for additional information. This would be burdensome.

Further, this approach is subject to various limitations. For example, when a user reads the text in a pop-up window on the screen, the electronic device may recognize the user's voice and execute a particular function. However, that is it. This kind of voice control would not provide more diversified types of control.

The above information is presented as background information only to assist with an understanding of the present disclosure.

### SUMMARY

According to an example embodiment of the present disclosure, an electronic device and method for controlling an electronic device using speech recognition, enabling control, e.g., selection and execution of at least one object contained in content displayed, using the user's voice are provided. For example, according to an example embodiment of the present disclosure, the user may perform various types of control, e.g., selection and execution of an object, using his/her voice when, for example, he/she experiences difficulty in controlling the electronic device by way of the conventional input schemes: e.g., when the electronic device is far away from the user, when the electronic device does not support a mouse, keyboard, or other input devices, or when the user's hands are not available, e.g., while driving.

According to an example embodiment of the present disclosure, an electronic device and method for controlling an electronic device using speech recognition are provided, enabling the voice control of content not specially generated for control using speech recognition but at least one object of the content with no modification.

According to an example embodiment of the present disclosure, an electronic device and method for controlling an electronic device using speech recognition are provided, enabling the execution in voice of various properties and controllable operations of an object contained in content, but not merely selection and execution of the object.

According to an Example embodiment of the present disclosure, an electronic device may comprise a microphone, a display, and a processor, wherein the processor may be configured to control the display to display, on the display, content including at least one object and at least one text corresponding to the at least one object, the at least one text obtained based on a resource comprising the content, to determine a first text corresponding to a voice received using the microphone from among the at least one text, and to execute a command corresponding to the received voice on a first object corresponding to the first text from among the at least one object based on at least one command registered to control the at least one object.

According to an example embodiment of the present disclosure, a method for controlling an electronic device using speech recognition may comprise displaying, on a display, content including at least one object and at least one text corresponding to the at least one object, the at least one text obtained based on a resource comprising the content, determining a first text corresponding to a voice received using a microphone from among the at least one text, and executing a command corresponding to the received voice on a first object corresponding to the first text from among the at least one object based on at least one command registered to control the at least one object.

According to an example embodiment of the present disclosure, a non-transitory machine-readable storage medium having recorded thereon a program which, when executed by a processor, causes an electronic device to use speech recognition. The program may comprise displaying, on a display, content including at least one object and at least one text corresponding to the at least one object, the at least one text obtained based on a resource comprising the content, determining a first text corresponding to a voice received using a microphone from among the at least one text, and executing a command corresponding to the received voice on a first object corresponding to the first text from among the at least one object based on at least one command registered to control the at least one object.

Other aspects, advantages, and salient features of the disclosure will become apparent to those skilled in the art from the following detailed description, which, taken in conjunction with the annexed drawings, discloses various example embodiments of the disclosure.

### BRIEF DESCRIPTION OF THE DRAWINGS

The above and/or other aspects, features and attendant advantages of the present disclosure will be more apparent and readily appreciated from the following detailed description, taken in conjunction with the accompanying drawings, in which like reference numerals refer to like elements, and wherein:

FIG. 1 is a diagram illustrating an example configuration of an electronic device according to an example embodiment of the present disclosure;

FIG. 2 is a flowchart illustrating example operations of generating and registering a command to control an electronic device using speech recognition according to an example embodiment of the present disclosure;

FIG. 3 is a flowchart illustrating example operations for generating a command to control an object to be displayed on a display of an electronic device according to an example embodiment of the present disclosure;

FIG. 4 is a flowchart illustrating example operations for controlling an object included in content by speech recognition of an electronic device according to an example embodiment of the present disclosure;

FIGS. 5 and 6 are diagrams illustrating examples of a screen on a display of an electronic device according to an example embodiment of the present disclosure;

FIGS. 7A, 7B and 7C are diagrams illustrating example screens where an electronic device sequentially displays GUIs and/or texts each of which corresponds to a respective one of objects according to designated degrees of importance according to an example embodiment of the present disclosure;

FIGS. 8A, 8B and 8C are diagrams illustrating example screens where an electronic device sequentially displays GUIs each of which corresponds to a respective one of objects according to designated degrees of importance according to an example embodiment of the present disclosure;

FIG. 9 is a diagram illustrating an example of an operation for controlling objects in content by speech recognition in an electronic device according to an example embodiment of the present disclosure;

FIG. 10 is a diagram illustrating an example of an operation for controlling objects in content by speech recognition in an electronic device according to an example embodiment of the present disclosure; and

FIG. 11 is a diagram illustrating an example of an operation for controlling objects in content by a user input in an electronic device according to an example embodiment of the present disclosure.

Throughout the drawings, like reference numerals will be understood to refer to like parts, components, and structures.

### DETAILED DESCRIPTION

Hereinafter, various example embodiments of the present disclosure are described with reference to the accompanying drawings. However, it should be appreciated that the present disclosure is not limited to the example embodiments and the terminology used herein, and all changes and/or equivalents or replacements thereto also belong to the scope of the present disclosure. The same or similar reference denotations may be used to refer to the same or similar elements throughout the specification and the drawings. It is to be understood that the singular forms “a,” “an,” and “the” include plural references unless the context clearly dictates otherwise. As used herein, the terms “A or B” or “at least one of A and/or B” may include all possible combinations of A and B. As used herein, the terms “first” and “second” may modify various components regardless of importance and/or order and are used to distinguish a component from another without limiting the components. It will be understood that when an element (e.g., a first element) is referred to as being (operatively or communicatively) “coupled with/to,” or “connected with/to” another element (e.g., a second element), it can be coupled or connected with/to the other element directly or via a third element.

As used herein, the terms “configured to” may be interchangeably used with other terms, such as “suitable for,” “capable of,” “modified to,” “made to,” “adapted to,” “able to,” or “designed to” in hardware and/or software in the context. Rather, the term “configured to” may refer to a situation in which a device can perform an operation together with another device or parts. For example, the term “processor configured (or set) to perform A, B, and C” may refer, for example, and without limitation, to a generic-purpose processor (e.g., a CPU or application processor) that may perform the operations by executing one or more software programs stored in a memory device or a dedicated processor (e.g., an embedded processor) for performing the operations.

For example, examples of the electronic device according to embodiments of the present disclosure may include at least one of a smartphone, a tablet personal computer (PC), a mobile phone, a video phone, an e-book reader, a desktop PC, a laptop computer, a netbook computer, a workstation, a server, a personal digital assistant (PDA), a portable multimedia player (PMP), a MP3 player, a medical device, a camera, or a wearable device. The wearable device may include at least one of an accessory-type device (e.g., a watch, a ring, a bracelet, an anklet, a necklace, glasses, contact lenses, or a head-mounted device (HMD)), a fabric- or clothes-integrated device (e.g., electronic clothes), a body attaching-type device (e.g., a skin pad or tattoo), or a body implantable device, or the like, but is not limited thereto. In some embodiments, examples of the smart home appliance may include at least one of a television, a digital video disk (DVD) player, an audio player, a refrigerator, an air conditioner, a cleaner, an oven, a microwave oven, a washer, a drier, an air cleaner, a set-top box, a home automation control panel, a security control panel, a TV box (e.g., Samsung HomeSync™, Apple TV™, or Google TV™), a gaming console (Xbox™, PlayStation™), an electronic dictionary, an electronic key, a camcorder, or an electronic picture frame, or the like, but is not limited thereto.

According to an embodiment of the present disclosure, the electronic device may include at least one of various medical devices (e.g., diverse portable medical measuring devices (a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global navigation satellite system (GNSS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, drones, automatic teller's machines (ATMs), point of sales (POS) devices, or internet of things (IoT) devices (e.g., a bulb, various sensors, a sprinkler, a fire alarm, a thermostat, a street light, a toaster, fitness equipment, a hot water tank, a heater, or a boiler), or the like, but is not limited thereto. According to various embodiments of the disclosure, examples of the electronic device may at least one of part of a piece of furniture, building/structure or vehicle, an electronic board, an electronic signature receiving device, a projector, or various measurement devices (e.g., devices for measuring water, electricity, gas, or electromagnetic waves), or the like, but is not limited thereto. According to embodiments of the present disclosure, the electronic device may be flexible or may be a combination of the above-enumerated electronic devices. According to an embodiment of the present disclosure, the electronic device is not limited to the above-listed embodiments. As used herein, the term “user” may denote a human or another device (e.g., an artificial intelligent electronic device) using the electronic device.

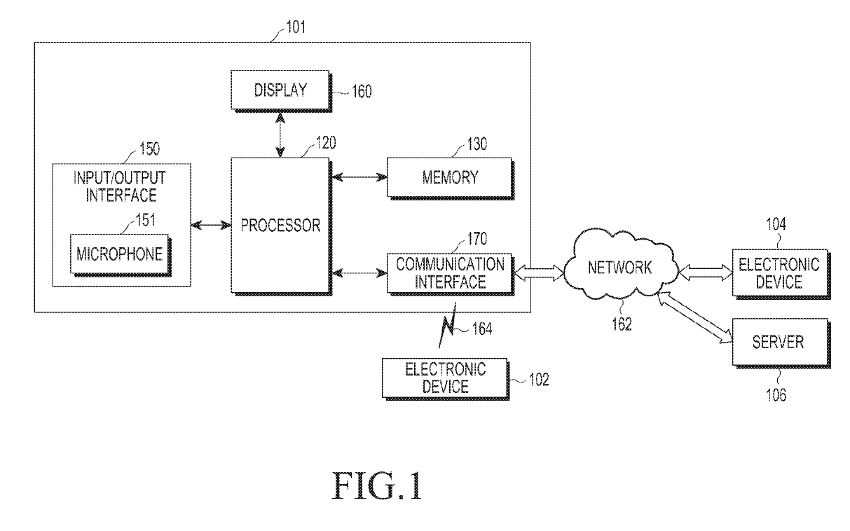

FIG. 1 is a diagram illustrating an example configuration of an electronic device 101 according to an example embodiment of the present disclosure.

The electronic device 101 may include a processor (e.g., including processing circuitry) 120, a memory 130, an input/output interface (e.g., including input/output circuitry) 150, a display 160, and a communication interface (e.g., inclduding communication circuitry) 170. In some embodiments, the electronic device 101 may exclude at least one of the components or may add another component.

The processor 120 may include various processing circuitry, such as, for example, and without limitation, one or more of a dedicated processor, a central processing unit (CPU), an application processor (AP), a communication processor (CP), or the like. The processor 120 may perform control on at least one of the other components of the electronic device 101, and/or perform an operation or data processing relating to communication.

The memory 130 may include a volatile and/or non-volatile memory. For example, the memory 130 may store commands or data related to at least one other component of the electronic device 101. According to an embodiment of the present disclosure, the memory 130 may store software and/or a program. The program may include, e.g., a kernel, middleware, an application programming interface (API), and/or an application program (or an application).

For example, the input/output interface 150 may include various input/output circuitry and transfer commands or data input from the user or other external device to other component(s) of the electronic device 101 or may output commands or data received from other component(s) of the electronic device 101 to the user or other external devices.

The input/output interface 150 may include, for example, and without limitation, a microphone 151.

The display 160 may include, e.g., a liquid crystal display (LCD), a light emitting diode (LED) display, an organic light emitting diode (OLED) display, or a microelectromechanical systems (MEMS) display, an electronic paper display, or the like, but is not limited thereto. The display 160 may display, e.g., various contents (e.g., text, images, videos, icons, or symbols) to the user. The display 160 may include a touchscreen and may receive, e.g., a touch, gesture, proximity or hovering input using an electronic pen or a body portion of the user.

For example, the communication interface 170 may include various communication circuitry and set up communication between the electronic device 101 and an external electronic device (e.g., a first electronic device 102, a second electronic device 104, or a server 106). For example, the communication interface 170 may be connected with the network 162 through wireless or wired communication to communicate with the external electronic device (e.g., the second external electronic device 104 or server 106). The communication interface 170 may establish a short-range wireless communication connection 164 with, for example, and without limitation an electronic device (e.g., electronic device 102), a network or any other device, or the like.

The wireless communication may include cellular communication which uses at least one of, e.g., long term evolution (LTE), long term evolution-advanced (LTE-A), code division multiple access (CDMA), wideband code division multiple access (WCDMA), universal mobile telecommunication system (UMTS), wireless broadband (WiBro), or global system for mobile communication (GSM). According to an embodiment of the present disclosure, the wireless communication may include at least one of, e.g., wireless fidelity (Wi-Fi), bluetooth, bluetooth low power (BLE), zigbee, near field communication (NFC), magnetic secure transmission (MST), radio frequency, or body area network (BAN). According to an embodiment of the present disclosure, the wireless communication may include global navigation satellite system (GNSS). The GNSS may be, e.g., global positioning system (GPS), global navigation satellite system (Glonass), Beidou navigation satellite system (hereinafter, “Beidou”) or Galileo, or the European global satellite-based navigation system. Hereinafter, the terms “GPS” and the “GNSS” may be interchangeably used herein. The wired connection may include at least one of, e.g., universal serial bus (USB), high definition multimedia interface (HDMI), recommended standard (RS)-232, power line communication (PLC), or plain old telephone service (POTS). The network 162 may include at least one of telecommunication networks, e.g., a computer network (e.g., local area network (LAN) or wide area network (WAN)), Internet, or a telephone network.

The first and second external electronic devices 102 and 104 each may be a device of the same or a different type from the electronic device 101. According to an embodiment of the present disclosure, all or some of operations executed on the electronic device 101 may be executed on another or multiple other electronic devices (e.g., the electronic devices 102 and 104 or server 106). According to an embodiment of the present disclosure, when the electronic device 101 should perform some function or service automatically or at a request, the electronic device 101, instead of executing the function or service on its own or additionally, may request another device (e.g., electronic devices 102 and 104 or server 106) to perform at least some functions associated therewith. The other electronic device (e.g., electronic devices 102 and 104 or server 106) may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used, for example.

According to an example embodiment of the present disclosure, an electronic device (e.g., the electronic device 101) may comprise a microphone (e.g., the microphone 151), a display (e.g., the display 160), and a processor (e.g., the processor 120), wherein the processor may be configured to control the display to display, on the display, content including at least one object and at least one text corresponding to the at least one object, the at least one text obtained based on a resource comprising the content, to determine a first text corresponding to a voice received using the microphone from among the at least one text, and to execute a command corresponding to the received voice on a first object corresponding to the first text from among the at least one object based on at least one command registered to control the at least one object.

According to an example embodiment of the present disclosure, the processor may analyze the resource, distinguish the at least one object in the content and determine at least one text corresponding to the at least one object based on a result of the analysis of the resource, and register the at least one command to control the at least one object based on the result of the analysis of the resource.

According to an example embodiment of the present disclosure, the processor may determine at least one non-text object among the at least one object based on the resource, and display, on the display, the at least one non-text object and the at least one text, with the at least one non-text object corresponding to the at least one text.

According to an example embodiment of the present disclosure, the processor may determine an object to which to apply a graphical user interface (GUI) from among the at least one object based on a property of the at least one object obtained based on the resource and display, on the display, the determined object and a GUI corresponding to the property of the determined object, with the determined object corresponding to the GUI.

According to an example embodiment of the present disclosure, the processor may adjust at least one of the size, color, and font of the at least one text corresponding to the at least one object based on at least one of the size, position, type, and logging information of the at least one object and display the adjusted text on the display.

According to an example embodiment of the present disclosure, the processor may determine an order of display, on the display, of the at least one text corresponding to the at least one object based on a determined degree of importance and sequentially display, on the display, the at least one text according to the determined order.

According to an example embodiment of the present disclosure, the processor may determine the degree of importance based on at least one of the size, position, type, and logging information of the at least one object.

According to an example embodiment of the present disclosure, the electronic device may further comprise a camera. The processor may determine an area to which a user's view is directed on the display based on an image obtained through the camera and display, on the display, a text corresponding to an object included in the determined area among the at least one object.

According to an example embodiment of the present disclosure, the processor may determine whether there are texts overlapping each other among the at least one text when displaying the at least one text on the display, and upon determining that there are overlapping texts, display only one of the overlapping texts based on a predetermined degree of importance.

According to an example embodiment of the present disclosure, the at least one object may include at least one of a text, an image, a video, an icon, a link, and an input area.

According to an example embodiment of the present disclosure, the content may include a webpage.

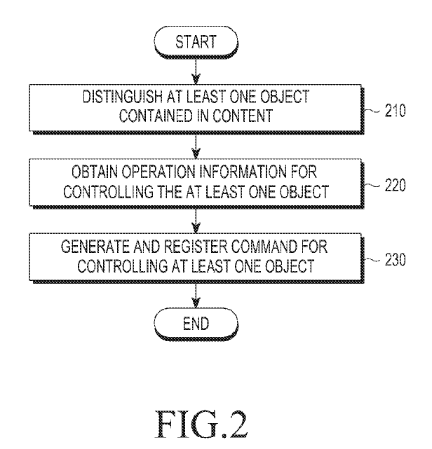

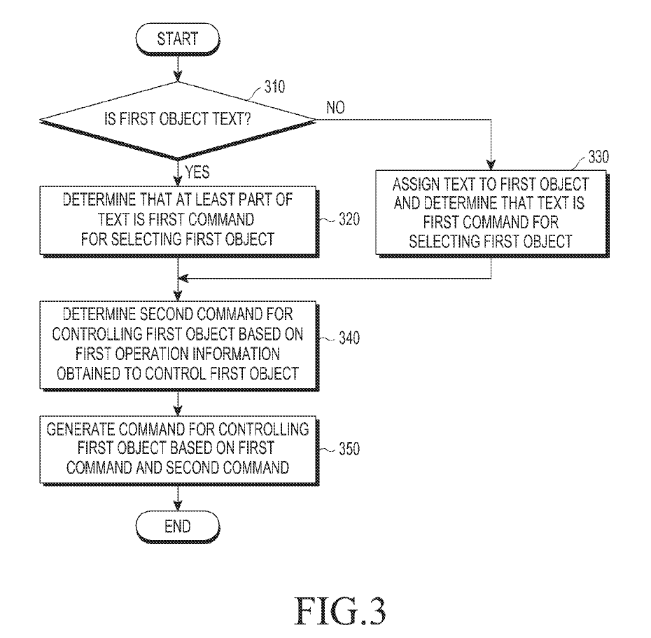

FIG. 2 is a flowchart illustrating example operations of generating and registering a command to control an electronic device (e.g., the electronic device 101) using speech recognition according to an example embodiment of the present disclosure. FIG. 3 is a flowchart illustrating example operations for generating a command to control an object to be displayed on a display of an electronic device (e.g., the electronic device 101) according to an example embodiment of the present disclosure.

Referring to FIG. 2, the electronic device may analyze resources comprising content, determine at least one object contained in the content and at least one operation to control the at least one object, and register a command for controlling the at least one object using a voice. The content may, for example, and without limitation, be a webpage including the resources. The content may be displayed on the electronic device and an external device connected with the electronic device. The resources may be hypertext markup language (HTML) documents, extensible markup language (XML) documents, or other standard documents.

In operation 210, the electronic device may distinguish at least one object contained in the content.

According to an embodiment of the present disclosure, the electronic device may obtain an object list of the objects contained in the content.

According to an embodiment of the present disclosure, the electronic device may analyze the resources of the content and distinguish the objects contained in the content based on a result of the analysis of the resources. For example, the electronic device may distinguish the objects contained in the content according to the type of tags included in the resources. For example, the objects may be texts, images, videos, icons, links, input areas, or other various ones.

In operation 220, the electronic device may obtain operation information for controlling the at least one object.

According to an embodiment of the present disclosure, the electronic device may obtain an operation information list of pieces of operation information for controlling the object(s) per object.

According to an embodiment of the present disclosure, the operation information may include a user control (input) for a corresponding object and at least one control operation of the electronic device.

According to an embodiment of the present disclosure, the electronic device may analyze the properties of each object and obtain operation information for controlling each object.

For example, the electronic device may obtain operation information including user controls, e.g., click, mouse-over, drag, or scroll, and at least one control operation, e.g., text-to-speech, copy text, and search for a particular command, of the object of the electronic device according to the user controls, based on the properties of each object defined in the resources.

For example, the electronic device may analyze the tags included in the resources of the content and obtain operation information controllable per object.

For example, when a property of a first object is defined in a resource of the content including the first object to change the color of the first object when the mouse cursor is moved, the electronic device may obtain, as operation information for controlling the first object, the movement of the mouse cursor and the operation of changing the color of the first object according to the movement of the mouse cursor, based on the property defined in the resource of the content.

As another example, where the first object is a link (also referred to as a hyperlink), the property of the first object may be defined in the resource of the content including the first object to move to another portion of the current screen or to a new page by an input, e.g., a click or touch. The electronic device may obtain, as operation information for controlling the first object, the operation of moving to the other portion of the current screen or the new page by an input, e.g., a click or touch, based on the property of the first object defined in the resource of the content.

As another example, where the first object is a text, a property of the first object may be defined in the resource of the content including the first object as a voice output by applying a text-to-speech (TTS) technique through a touch, selection of a text through a drag, and/or search through a drag and click. The electronic device may obtain, as operation information for controlling the first object, the operation of outputting a voice by applying a TTS technique through a touch, selecting a text through a drag, and/or searching through a drag and click based on the property of the first object defined in the resource of the content.

According to an embodiment of the present disclosure, operation information may previously be designated per type of object.

For example, operation information may previously be designated per type of object in the resource of the content. Specifically, operation information may be defined as the tag included in the resource of the content per object type.

As another example, operation information may previously be designated per object type in the electronic device.

In operation 230, the electronic device may generate and register a command for controlling the at least one object based on the at least one object and the at least one piece of object operation information.

According to an embodiment of the present disclosure, the electronic device may generate and register at least one command (also referred to as a text command) based on the at least one object and the at least one piece of object operation information.

According to an embodiment of the present disclosure, the command may include a selection portion for specifying the object and a control portion for controlling the object. For example, the electronic device may determine or select a text corresponding to each object and generate or select a first command that is a selection portion for specifying each object. Where the object is a text, the electronic device may select a word or sentence in the text as the first command. Where the object is not a text, the electronic device may determine the first command based on the resource of the content including the object. The electronic device may generate a second command that is a control portion corresponding to each piece of operation information per object.

An operation for generating such a command is described in greater detail with reference to FIG. 3. Referring to FIG. 3, the command may be determined as a different one depending on whether the first object is a text. For example, where the first object is a text, the electronic device may determine that the whole or some words of the text are the first command for selecting the first object. Where the first object is not a text but is, e.g., an image or icon, the electronic device may enable a number(s), letter(s) (e.g. alphabet), or other automated identity (ID)-type command to be provided as the first command for selecting the first object.

In operation 310, the electronic device may determine whether the first object is a text. For example, the electronic device may determine whether the first object is a text by analyzing the resource of the content including the first object. When the first object is determined to be a text in operation 310, the electronic device may perform operation 320, otherwise operation 330.

In operation 320, the electronic device may determine that at least part (a word or sentence) of the text which is the first object is the first command for selecting the first object.

According to an embodiment of the present disclosure, the electronic device may store conditions for determining the first command and determine the first command using the stored conditions.

For example, the electronic device may identify a subject portion (e.g., a subject word or sentence) of the text by analyzing the tag of the resource, and the electronic device may determine that the subject portion is the first command.

As another example, the electronic device may identify the first sentence in the text by analyzing the tag of the resource, and the electronic device may determine that the first sentence is the first command.

For example, the electronic device may analyze the resource to identify a word or sentence that is shown relatively thicker or bigger, or underlined, and/or in a different font from the other words or sentences in the text and determine the emphasized word or sentence, and the electronic device may determine that the emphasized word or sentence is the first command.

By way of example, the electronic device may determine that all of the words and/or sentences in the text are the first command.

In operation 330, the electronic device may assign a text to the first object, and determine that the text is the first command for selecting the first object.

According to an embodiment of the present disclosure, the text may be a number(s) or letter(s) (e.g. alphabet), but is not limited thereto.

According to an embodiment of the present disclosure, the text may be displayed in the shape of a tool tip on the screen.

According to an embodiment of the present disclosure, the electronic device may analyze the property of the first object from the resource and assign a text.

For example, the electronic device may give a text to the first object considering the properties of the first object, e.g., the type of the first object, the position of display of the first object, where the first object is positioned in the resource, and/or the size of the first object to be displayed.

For example, where the first object-containing content includes a non-text object in addition to the first object, the text of the first object may be a text distinct from a text for the non-text object. For example, where the content includes a plurality of non-text objects, the electronic device may assign a different text to each non-text object based on the properties. For example, where the content includes three non-text objects, the electronic device may assign the numbers 1, 3, and 2 to a first non-text object which is to be displayed in the largest size, a second non-text object which is to be displayed in the smallest size, and the other non-text objects, respectively.

In operation 340, the electronic device may determine a second command for controlling the first object based on first operation information obtained to control the first object.

According to an embodiment of the present disclosure, the first operation information may include a first user control and a first control operation according to the first user control. For example, the electronic device may extract the first user control and the first control operation according to the first user control in the first control operation. The electronic device may also generate the second command corresponding to the first user control, and the electronic device may enable the command to correspond to the first control operation. For example, when the first user control is a click, mouse-over, drag, scroll, TTS, or search, the second command may be a click, mouse-over, drag, scroll, TTS, or search.

According to an embodiment of the present disclosure, the electronic device may generate a plurality of second commands. For example, the electronic device may generate various second commands that the user may speak out for the first user control, and the electronic device may enable the first operation to be executed even when the user speaks out only any one of the second commands.

According to an embodiment of the present disclosure, the second command may be one previously designated per user control, or the second command may be one that the electronic device automatically generates per control operation based on, e.g., accrued user voice commands or statistical information about multiple persons' voice commands.

In operation 350, the electronic device may generate a command for controlling the first object based on the first command and the second command. For example, the electronic device may generate a command including the first command and the second command.

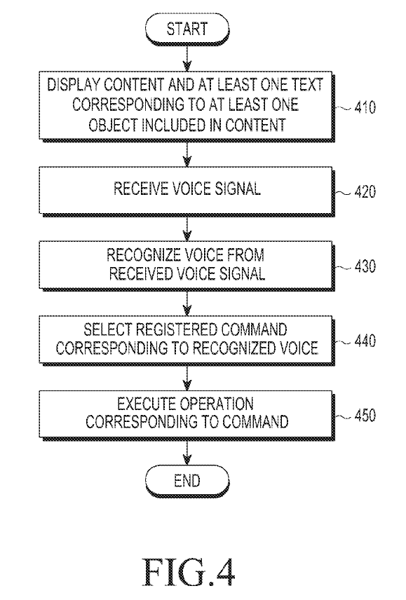

FIG. 4 is a flowchart illustrating example operations for controlling an object included in content by speech recognition of an electronic device (e.g., the electronic device 101) according to an example embodiment of the present disclosure.

Referring to FIG. 4, the electronic device may display content on the display so that a text corresponds to a non-text object, but not a text object contained in the content. The electronic device may execute a control operation for an object by recognizing the user's voice.

According to an embodiment of the present disclosure, the user may speak out, e.g., “12 click” or “click 12”, when intending to click a command-assigned picture using the number “12.” Upon receiving the user's voice, the electronic device may determine whether there is a command corresponding to the voice spoken out among commands registered. For example, the electronic device may determine the command corresponding to the spoken-out voice by comparing the spoken-out voice with the registered commands. For example, the electronic device may recognize the number “12” as a first command of a selection portion for specifying an object and a “click” as a second command of a control portion of the object 12 recognized. Accordingly, the electronic device may execute a control operation corresponding to the determined command, e.g., the operation of clicking the object 12.

In operation 410, the electronic device may display the content and at least one text corresponding to at least one object included in the content.

According to an embodiment of the present disclosure, the content may be a webpage, and the at least one object may be, but is not limited to, an image, text, video, or icon.

According to an embodiment of the present disclosure, the electronic device may receive the content including the at least one object, and the electronic device may execute the operation of generating a command as set forth above in connection with FIGS. 2 and 3. The electronic device may display the received content and the texts each of which has been assigned to a respective one of the non-text objects included in the content so that each text corresponds to the respective one of the non-text objects. The texts each of which has been assigned to the respective one of the non-text objects may be a text assigned to each non-text object among the objects included in the content that is to be displayed as per operation 330 of FIG. 3 while the operation of generating a command is executed. The content and the texts each of which has been assigned to a respective one of the non-text objects may simultaneously be display. Alternatively, after the content is displayed on the display, the texts each of which has been assigned to a respective one of the non-text objects may additionally be displayed by, e.g., a user control.

According to an embodiment of the present disclosure, the electronic device may receive content including at least one object, receive texts each of which has been assigned to a respective one of the non-text objects in the content, and receive at least one registered command each of which corresponds to a respective one of the objects in the content. The electronic device may display the received content and the texts each of which has been assigned to a respective one of the non-text objects included in the content so that each text corresponds to the respective one of the non-text objects. The content and the texts each of which has been assigned to a respective one of the non-text objects may simultaneously be display. Alternatively, after the content is displayed on the display, the texts each of which has been assigned to a respective one of the non-text objects may additionally be displayed by, e.g., a user control.

In operation 420, the electronic device may receive a voice signal. For example, the electronic device may receive the user's voice using a microphone.

In operation 430, the electronic device may recognize a voice from the received voice signal. For example, the electronic device may recognize the voice from the received voice signal using a speech recognition technique. The electronic device may convert the received voice signal into a text, and the electronic device may recognize the converted text.

In operation 440, the electronic device may select a registered command corresponding to the recognized voice.

For example, the electronic device may determine the command corresponding to the recognized voice by comparing the recognized voice with registered commands. For example, the electronic device may determine a first command of a selection portion for specifying an object in the content and a second command of a control portion for controlling the first object based on the recognized voice.

As another example, the electronic device may determine a command corresponding to what the recognized voice intends using natural language processing (NLP). For example, where the recognized voice says, “Touch the first object”, the electronic device may determine what the recognized voice intends by applying NLP, and the electronic device may enable it to be recognized as the registered command “Click the first object,” thereby determining the command of the “Click the first object.”

In operation 450, the electronic device may execute an operation corresponding to the command. For example, the electronic device may execute a second command included in the command.

According to an embodiment of the present disclosure, upon performing operation 410 for displaying the content and the at least one text corresponding to the at least one object in the content, the electronic device may additionally display a graphical user interface (GUI). For example, the electronic device may identify the properties of each object in the content based on the resources of the content and determine an object to which the GUI is to be applied among the objects in the content based on the properties identified. As another example, the electronic device may determine an object to which to apply the GUI among the objects in the content based on the command corresponding to each object. Thereafter, the electronic device may display the determined object and the GUI corresponding to the property or command of the determined object, with the determined object corresponding to the GUI. Accordingly, the GUI may serve as a guide that assists the user in precisely speaking out a command for controlling a particular object.

According to an embodiment of the present disclosure, the GUI may be, but is not limited to, an icon, an image, or a tool tip.

According to an embodiment of the present disclosure, the properties may include the type of object, operation information about the objects, and/or other various information. For example, where the operation information about the first object is entering text or clicking a second button between a first button and the second button, rather than a basic operation, such as a click, the electronic device may display a pre-designated GUI on the display, with the GUI corresponding to the first object, allowing the user to easily utter a voice command.

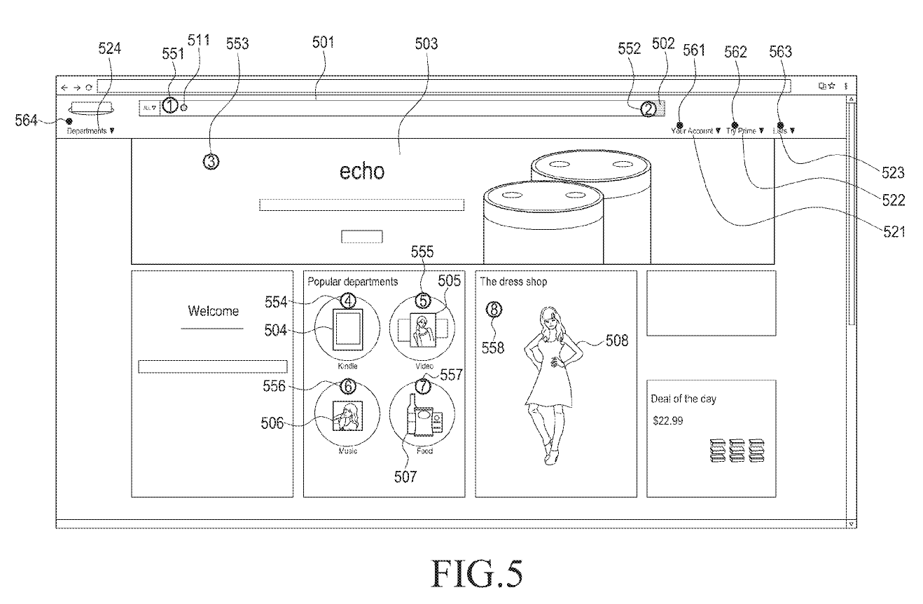

FIG. 5 is a diagram illustrating an example display screen of an electronic device (e.g., the electronic device 101) according to an example embodiment of the present disclosure.

Referring to FIG. 5, the electronic device may display, on the display, a webpage and tool tips 551, 552, 553, 554, 555, 556, 557, and 558 assigned the texts, e.g., numbers 1 to 8, each of which corresponds to a respective one of image objects 501, 502, 503, 504, 505, 506, 507, and 508. The electronic device may display a green guide GUI 511 on an object 501 having a text entry property. The electronic device may display each of yellow guide GUIs 561, 562, 563, and 564 on a respective one of objects 521, 522, 523, and 524 having the property of being expanded through a mouse-over.

According to the embodiment of FIG. 5 above, the electronic device may display a corresponding text to overlap each image object. Displaying the identically sized texts on all of the objects in performing such operation would cause the user to feel unnatural about the objects displayed on the electronic device. For example, given the layout of the screen of the electronic device, a relatively image object may take up a major part of the content. Reflecting such nature to displaying text leads to the user easily recognizing the text and uttering a voice command.

Thus, according to an embodiment of the present disclosure, the electronic device may enable the text to be displayed in a different size depending on the size of each image object in the content displayed on the screen of the electronic device.

According to an embodiment of the present disclosure, the electronic device may resize and display the text corresponding to the size of each image object. The electronic device may set the size of the text corresponding to the size of each image object by identifying part of the resources of the content which is related to the size of each image object.

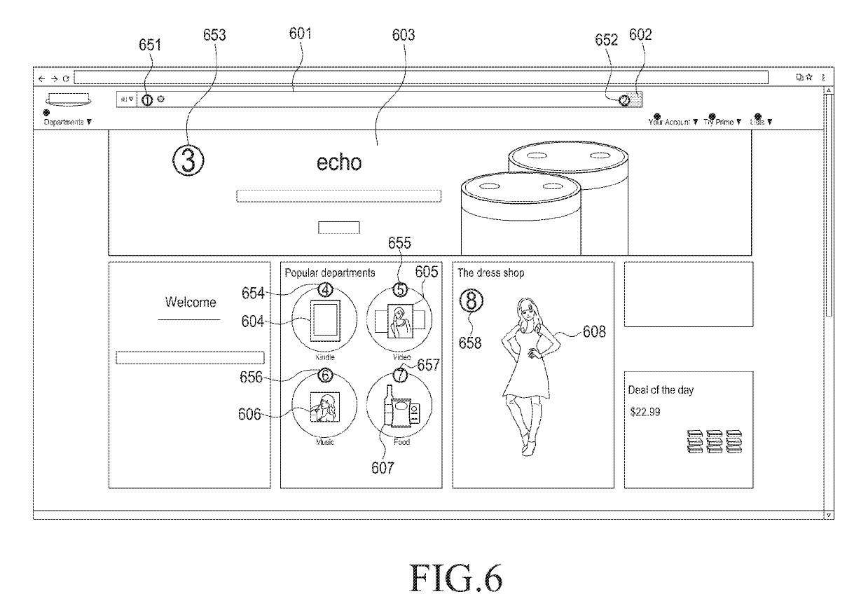

Referring to FIG. 6, the electronic device may enable the tool tip 653 of the largest image object 603 among the image objects 601, 602, 603, 604, 605, 606, 607, and 608 to be displayed bigger than the tool tips 651, 652, 654, 655, 656, 657, and 658 of the other objects 601, 602, 604, 605, 606, 607, and 608. The electronic device may enable the tool tips 651 and 652 of the smallest image objects 601 and 602 to be displayed smaller than the tool tips 653, 654, 655, 656, 657, and 658 of the other objects 603, 604, 605, 606, 607, and 608.

The electronic device may likewise apply the embodiment of resizing the texts of the image objects to the GUIs, resizing the GUIs corresponding to the size of each of the objects to which the GUIs are applied.

Generally, simultaneously displaying all of the GUIs corresponding to the objects and the texts corresponding to the image objects along with the content, e.g., a webpage, may result in the screen looking untidy or the user feeling unpleasant. To address such issues, according to an embodiment of the present disclosure, the electronic device may classify the objects according to designated degrees of importance and determine the order of display of the GUIs and texts based on the same.

According to an embodiment of the present disclosure, the electronic device may classify the objects in the content according to relative degrees of importance, e.g., in the order of an input window, a larger object, a smaller object, and an advertisement object for advertising a particular product, and the electronic device may determine order layers for displaying the GUIs and/or texts based on the same. For example, when a user input is made on a start trigger to utter a voice command, the electronic device may sequentially display the GUIs and/or the texts according to designated order layers.

According to an embodiment of the present disclosure, the electronic device may determine the degrees of importance of the objects based on, e.g., the type, size, and/or position of the objects, and the electronic device may determine an order of display of the GUI and/or text corresponding to each object depending on the degree of importance of the object. For example, the electronic device may determine that as the size of the object increases, the degree of importance increases, and the electronic device may display the GUIs and/or texts each of which corresponds to a respective one of the objects in descending order of importance, e.g., from the largest to the smallest size. Where some objects have the same degree of importance, the electronic device may simultaneously display the GUIs and/or texts corresponding to the objects in the same order. The electronic device may determine that as the position of the object comes closer to the center of the screen, the degree of importance increases, and the electronic device may display the GUIs and/or texts each of which corresponds to a respective one of the objects in a designated area in descending order of importance, e.g., from the closest to the farthest from the center of the screen.

The electronic device may determine the degrees of importance of the objects based on, e.g., the logging information (e.g., the number of times in which the object has been selected) in the content, and the electronic device may determine an order of display of the GUI and/or text corresponding to each object depending on the degree of importance of the object. The electronic device may log the information about the selection count for a particular object in the content and utilize the information as metadata. For example, the electronic device may determine that as the selection count for the object increases, the degree of importance increases, and the electronic device may display the GUIs and/or texts each of which corresponds to a respective one of the objects in descending order of importance, e.g., from the largest to the smallest selection count.

According to an embodiment of the present disclosure, the electronic device may determine the degrees of importance of the objects based on the direction that the user views the content, and the electronic device may determine an order of display of the GUI and/or text corresponding to each object depending on the degree of importance of the object. For example, the electronic device may obtain the user's image using a camera, determine, by a face recognition technique, at least a portion of the screen of the electronic device to which the user's view is directed in the user's image obtained, and determine that the determined portion has a higher degree of importance while the rest of the screen has a lower degree of importance. For example, the electronic device may display the GUI and/or text corresponding to each object in the higher-importance portion determined and then display the GUIs each of which corresponds to a respective one of the objects in the rest of the screen.

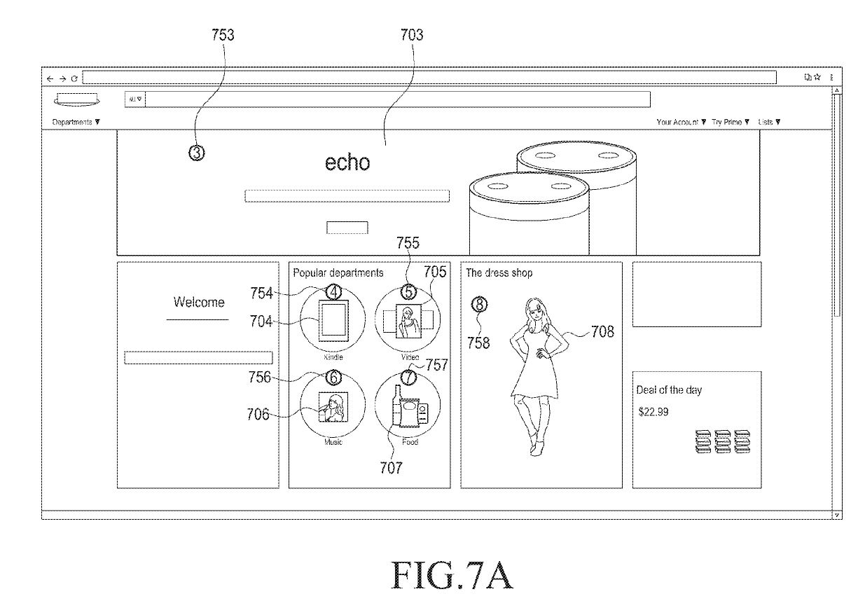

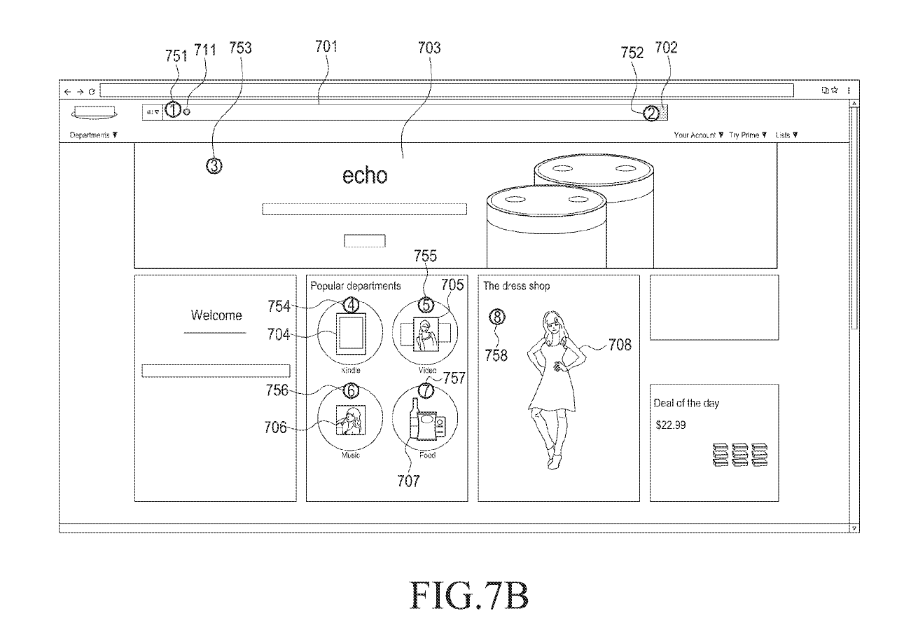

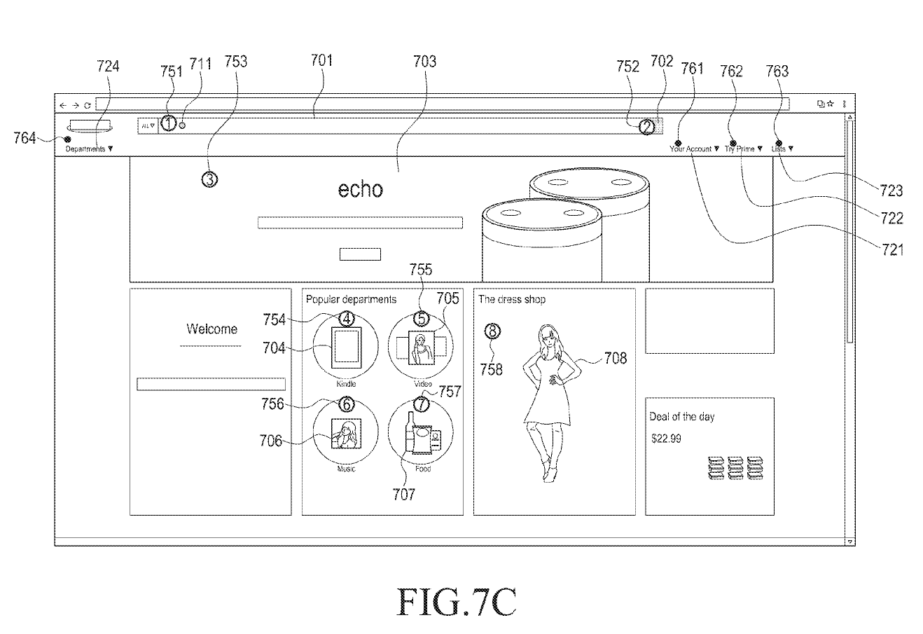

FIGS. 7A, 7b and 7C are diagrams illustrating example screens where an electronic device sequentially displays GUIs and/or texts each of which corresponds to a respective one of objects according to designated degrees of importance according to an example embodiment of the present disclosure.

Referring to FIGS. 7A, 7B and 7C, based on at least one of the above-described conditions for determining importance, the electronic device may designate image objects 703, 704, 705, 706, 707, and 708 for links among the objects, as first-importance objects, an image object 701 for entry in a search input window and an image object 702 for executing a search as second-importance objects, and other menu objects 721, 722, 723, and 724 as third-importance objects.

Upon executing a webpage or a function for speech recognition, the electronic device may first display a screen as illustrated in FIG. 7A based on the designated degrees of importance. Referring to FIG. 7A, the electronic device may display first tool tips 753, 754, 755, 756, 757, and 758 each of which corresponds to a respective one of the link objects 703, 704, 705, 706, 707, and 708 which have been designated as the first-importance objects.

Under a designated condition, e.g., when a predetermined time elapses or as per a user control, the electronic device may then display a screen as illustrated in FIG. 7B. For example, while displaying the first tool tips 753, 754, 755, 756, 757, and 758, the electronic device may additionally display the second tool tips 751 and 752 respectively corresponding to the image object 701 for entry and the image object 702 for executing a search, which have been designated as the second-importance objects, together with a first GUI 711 corresponding to the image object 701 for entry.

As per the designated condition, the electronic device may then display a screen as illustrated in FIG. 7C. For example, while displaying the first tool tips 753, 754, 755, 756, 757, and 758, the second tool tips 751 and 752, and the first GUI 711, the electronic device may additionally display second GUIs 761, 762, 763, and 764 respectively corresponding to the other objects 721, 722, 723, and 724 which have been designated as the third-importance objects.

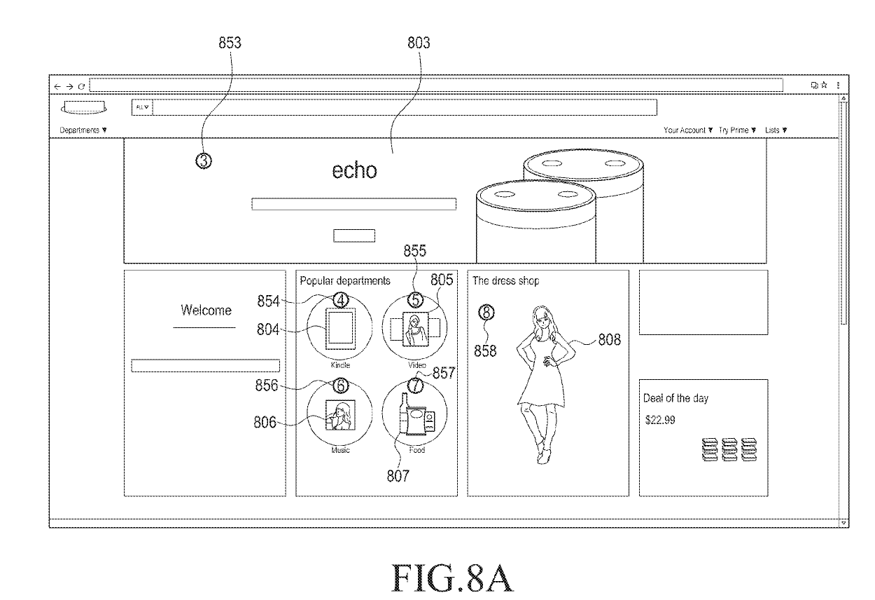

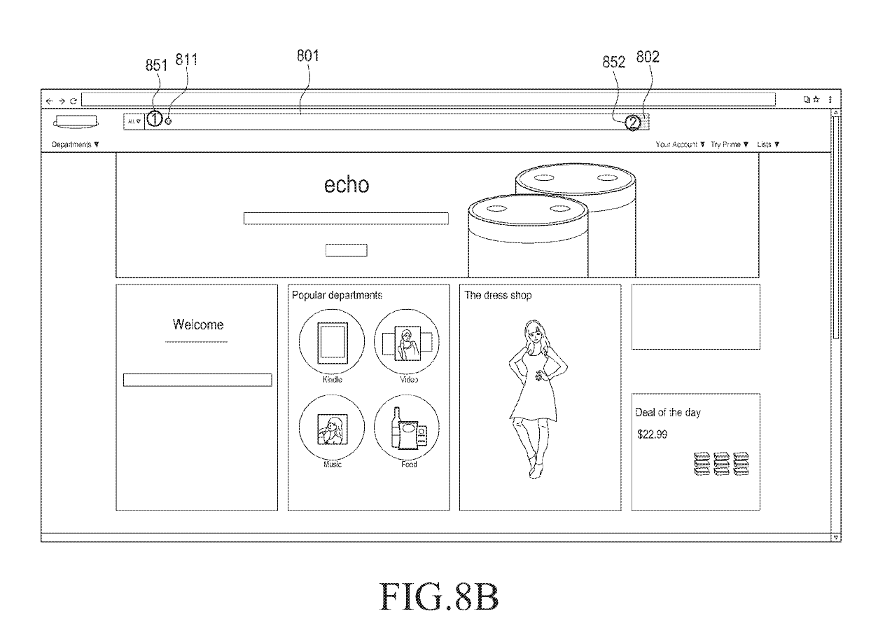

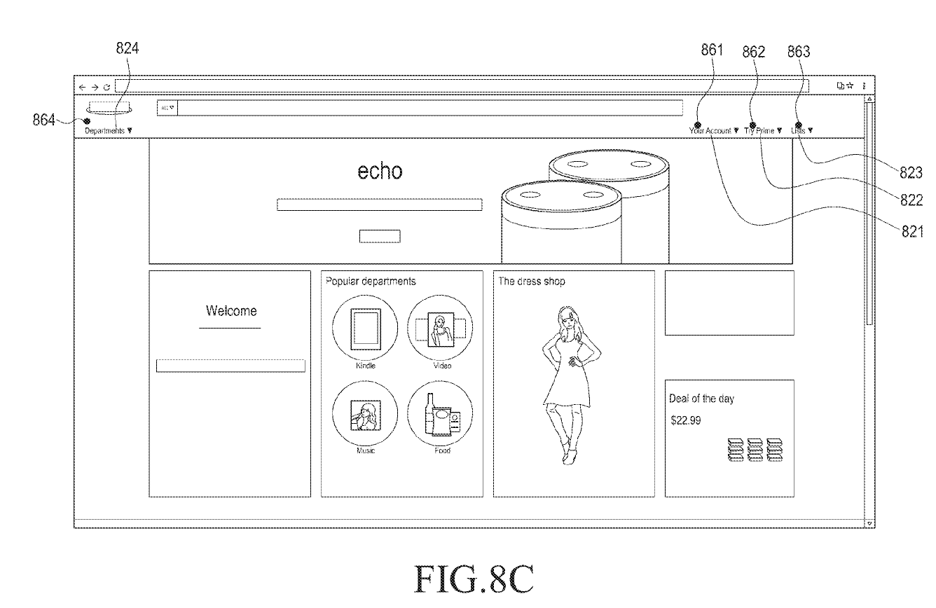

FIGS. 8a to 8c are views illustrating example screens where an electronic device sequentially displays GUIs each of which corresponds to a respective one of objects according to designated degrees of importance according to an embodiment of the present disclosure.

FIGS. 8A, 8B and 8C are diagrams illustrating example screens where an electronic device sequentially displays GUIs and/or texts each of which corresponds to a respective one of objects according to designated degrees of importance according to an example embodiment of the present disclosure.

Referring to FIGS. 8A, 8B and 8C, based on at least one of the above-described conditions for determining importance, the electronic device may designate image objects 803, 804, 805, 806, 807, and 808 for links among the objects, as first-importance objects, an image object 801 for entry in a search input window and an image object 802 for executing a search as second-importance objects, and other menu objects 821, 822, 823, and 824 as third-importance objects.

Upon executing a webpage or a function for speech recognition, the electronic device may first display a screen as illustrated in FIG. 8A based on the designated degrees of importance. Referring to FIG. 8A, the electronic device may display first tool tips 853, 854, 855, 856, 857, and 858 each of which corresponds to a respective one of the link objects 803, 804, 805, 806, 807, and 808 which have been designated as the first-importance objects.

Under a designated condition, e.g., when a predetermined time elapses or as per a user control, the electronic device may then display a screen as illustrated in FIG. 8B. For example, after terminating the display of the first tool tips 853, 854, 855, 856, 857, and 858, the electronic device may display the second tool tips 851 and 852 respectively corresponding to the image object 801 for entry and the image object 802 for executing a search, which have been designated as the second-importance objects, together with a first GUI 811 corresponding to the image object 801 for entry.

As per the designated condition, the electronic device may then display a screen as illustrated in FIG. 8C. For example, after terminating the display of the second tool tips 851 and 852 and the first GUI 811, the electronic device may display second GUIs 861, 862, 863, and 864 respectively corresponding to the other objects 821, 822, 823, and 824 which have been designated as the third-importance objects.

According to an embodiment of the present disclosure, the electronic device may display a GUI and/or text corresponding to at least one object that is positioned where the user's view is directed to the content. For example, the electronic device may obtain the user's image using a camera and determine, by a face recognition technique, at least a portion of the screen of the electronic device to which the user's view is directed in the user's image obtained. The electronic device may display GUIs and/or texts each of which corresponds to a respective one of the objects in the determined portion.

According to an embodiment of the present disclosure, where some GUIs and/or texts are expected to overlap each other when displaying the GUIs and/or texts on the objects, the electronic device may display only the GUI and/or text corresponding to the object of the largest importance among the GUIs and/or texts of the electronic device. Where some GUIs and/or texts are expected to overlap each other when displaying the GUIs and/or texts on the objects but the GUIs and/or texts hidden by the overlap are determined to be recognizable, the electronic device may display the GUIs and/or texts, with them overlaid one over another.

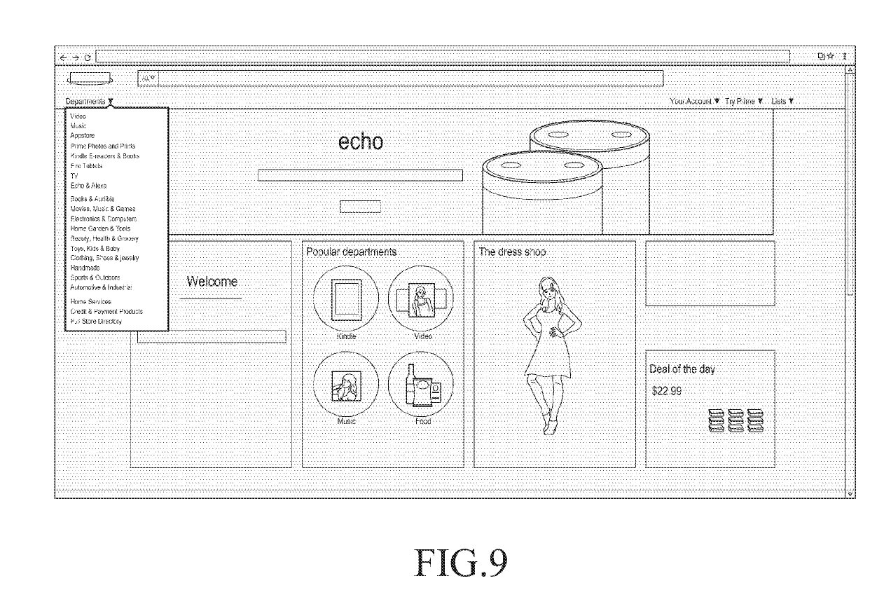

FIG. 9 is a diagram illustrating an example operation for controlling objects in content by speech recognition in an electronic device according to an example embodiment of the present disclosure.

Referring to FIG. 9, e.g., where the user displays (e.g., expand-and-display) a detailed menu for “Departments,” the user may speak a voice command “Cursor on departments.” Upon receiving the voice command, the electronic device may determine a command corresponding to the spoken-out voice by comparing the spoken-out voice with registered commands. For example, the electronic device may recognize the “Departments” as a first command of a selection portion for specifying an object and the “Cursor on” as a second command of a control portion of the object “Departments” recognized. According to an embodiment of the present disclosure, the electronic device may perform a control operation corresponding to the determined command, e.g., move the cursor on the “Departments,” and the electronic device may display a detailed menu for the “Departments.”

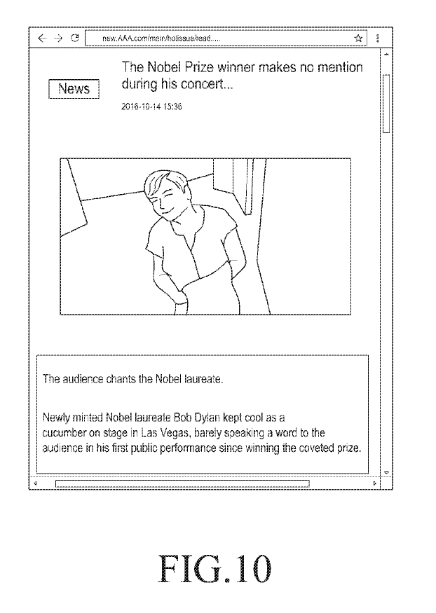

FIG. 10 is a diagram illustrating an example operation for controlling objects in content by speech recognition in an electronic device according to an example embodiment of the present disclosure.

Referring to FIG. 10, upon intending to execute a TTS function on a particular article in a webpage displayed, the user may utter a voice command “Read ‘The audience chants the Nobel laureate.’” Upon receiving the voice command, the electronic device may determine a command corresponding to the spoken-out voice by comparing the spoken-out voice with registered commands. For example, the electronic device may recognize the “The audience chants the Nobel laureate” as a first command of a selection portion for specifying an object and the “Read” as a second command of a control portion of the object “Departments” recognized. According to an embodiment of the present disclosure, the electronic device may execute a control operation corresponding to the determined command, e.g., a TTS function for a full article including the “The audience chants the Nobel laureate.” Additionally, unless the full article is displayed, the electronic device may enable the full article to be displayed.

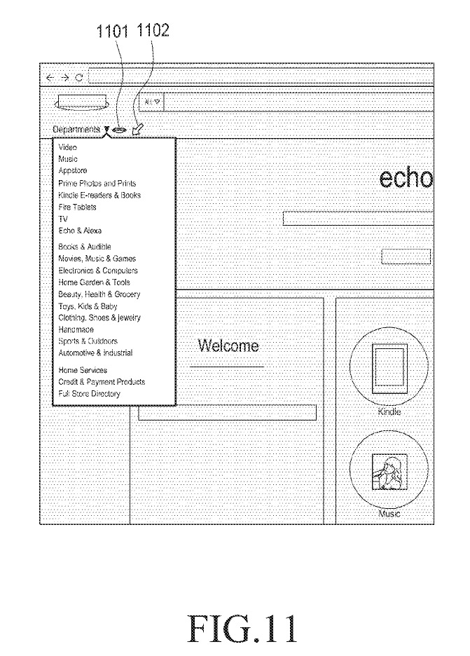

FIG. 11 is a diagram illustrating an example operation for controlling objects in content by a user input in an electronic device according to an example embodiment of the present disclosure.

Referring to FIG. 11, a guide GUI 1101 indicating that the user may control through a voice command and/or a guide GUI 1102 indicating that the user may control through a mouse-over may be displayed on a menu, such as the “Department,” which displays (e.g., expands-and-displays) a detailed menu. Accordingly, the user may intuitively recognize a control scheme from the form of the guide GUI 1101 or 1102. For example, where the user places the mouse cursor on the “Department” menu by uttering a voice command “Cursor on departments” or as per a user control, the electronic device may display a detailed menu of the “Departments.”

According to an example embodiment of the present disclosure, a method for controlling an electronic device (e.g., the electronic device 101) using speech recognition may comprise displaying, on a display, content including at least one object and at least one text corresponding to the at least one object, the at least one text obtained based on a resource comprising the content, determining a first text from among the at least one text corresponding to a voice received using a microphone, and executing a command corresponding to the received voice on a first object corresponding to the first text among the at least one object based on at least one command registered to control the at least one object.

According to an example embodiment of the present disclosure, the method may further comprise analyzing the resource, distinguishing the at least one object in the content and determining at least one text corresponding to the at least one object based on a result of the analysis of the resource, and registering the at least one command to control the at least one object based on the result of the analysis of the resource.

According to an example embodiment of the present disclosure, displaying, on the display, the at least one text corresponding to the at least one object may include determining at least one non-text object from among the at least one object based on the resource and displaying, on the display, the at least one non-text object and the at least one text, with the at least one non-text object corresponding to the at least one text.

According to an example embodiment of the present disclosure, the method may further comprise determining an object to which to apply a graphical user interface (GUI) from among the at least one object based on a property of the at least one object obtained based on the resource and displaying, on the display, the determined object and a GUI corresponding to the property of the determined object, with the determined object corresponding to the GUI.

According to an example embodiment of the present disclosure, displaying, on the display, the at least one text corresponding to the at least one object may include adjusting at least one of the size, color, and font of the at least one text corresponding to the at least one object based on at least one of the size, position, type, and logging information of the at least one object and displaying the adjusted text on the display.

According to an example embodiment of the present disclosure, displaying, on the display, the at least one text corresponding to the at least one object may include determining the degree of importance based on at least one of the size, position, type, and logging information of the at least one object, determining an order of display, on the display, of the at least one text corresponding to the at least one object based on a determined degree of importance, and sequentially displaying, on the display, the at least one text according to the determined order.

According to an example embodiment of the present disclosure, the method may further comprise determining an area to which a user's view is directed on the display based on an image obtained through a camera. Displaying, on the display, the at least one text corresponding to the at least one object may include displaying, on the display, a text corresponding to an object included in the determined area among the at least one object.

According to an example embodiment of the present disclosure, displaying, on the display, the at least one text corresponding to the at least one object may include determining whether there are texts overlapping and displayed among the at least one text, and upon determining that there are overlapping texts, displaying only one of the overlapping texts based on a predetermined degree of importance.

According to an example embodiment of the present disclosure, there may be provided a non-transitory, machine-readable storage medium having recorded thereon a program, which when executed by a processor, causes an electronic device (e.g., the electronic device 101) using speech recognition to perform various operations. The operations may comprise displaying, on a display, content including at least one object and at least one text corresponding to the at least one object, the at least one text obtained based on a resource comprising the content, determining a first text from among the at least one text corresponding to a voice received using a microphone, and executing a command corresponding to the received voice on a first object corresponding to the first text among the at least one object based on at least one command registered to control the at least one object.

As used herein, the term “module” may include, for example, and without limitation, a unit configured in hardware, software, or firmware, or any combination thereof, and may interchangeably be used with other terms, e.g., “logic,” “logic block,” “part,” or “circuit.” The module may be a single integral part or a minimum unit or part of performing one or more functions. The module may be implemented mechanically or electronically and may include, for example, and without limitation, a dedicated processor, a CPU, an application-specific integrated circuit (ASIC) chip, field-programmable gate arrays (FPGAs), or programmable logic device, that has been known or to be developed in the future as performing some operations.

According to an embodiment of the present disclosure, at least a part of the device (e.g., modules or their functions) or method (e.g., operations) may be implemented as instructions stored in a computer-readable storage medium (e.g., the memory 130), e.g., in the form of a program module. The instructions, when executed by a processor (e.g., the processor 120), may enable the processor to carry out a corresponding function. The computer-readable medium may include, e.g., a hard disk, a floppy disc, a magnetic medium (e.g., magnetic tape), an optical recording medium (e.g., compact disc-read only memory (CD-ROM), digital versatile disc (DVD), magnetic-optical medium (e.g., floptical disk), or an embedded memory. The instruction(s) may include a code created by a compiler or a code executable by an interpreter. Modules or programming modules in accordance with various embodiments of the present disclosure may include at least one or more of the aforementioned components, omit some of them, or further include other additional components. Operations performed by modules, programming modules or other components in accordance with various embodiments of the present disclosure may be carried out sequentially, in parallel, repeatedly or heuristically, or at least some operations may be executed in a different order or omitted or other operations may be added.

As is apparent from the foregoing description, according to the various example embodiments of the present disclosure, the electronic device and method for controlling an electronic device using speech recognition may execute, in a voice input, the properties and various user control commands of a certain object contained in the content displayed on the electronic device.

According to the various example embodiments of the present disclosure, the electronic device and method for controlling an electronic device using speech recognition enable the user to easily figure out objects that the user may presently choose and execute and the properties of the object when the user performs voice control on the objects contained in the content on the screen.

While various example embodiments have been described, it will be understood that the various example embodiments are intended to be illustrative and not limiting. Accordingly, one or ordinary skill in the art will understand that various modifications, variations and alternatives may be made without departing from the true spirit and full scope of the present disclosure, as defined, for example, in the appended claims and their equivalents.

What is claimed is:

1. An electronic device, comprising:
a microphone;
a display; and
a processor, wherein the processor is configured to control the display to display, on the display, content including at least one object and at least one text corresponding to the at least one object, the at least one text obtained based on a resource comprising the content, to determine a first text from among the at least one text corresponding to a voice received using the microphone, and to execute a command corresponding to the received voice on a first object corresponding to the first text from among the at least one object based on at least one command registered to control the at least one object.

2. The electronic device of claim 1, wherein the processor is configured to analyze the resource, to distinguish the at least one object in the content and to determine at least one text corresponding to the at least one object based on a result of the analysis of the resource, and to register the at least one command to control the at least one object based on the result of the analysis of the resource.

3. The electronic device of claim 1, wherein the processor is configured to determine at least one non-text object from among the at least one object based on the resource and to control the display to display, on the display, the at least one text by making the at least one object correspond to the at least one non-text object.

4. The electronic device of claim 1, wherein the processor is configured to determine an object to which to apply a graphical user interface (GUI) from among the at least one object based on a property of the at least one object obtained based on the resource and to control the display to display, on the display, a GUI corresponding to the property of the determined object by making the GUI corresponding to the property of the determined object correspond to the determined object.

5. The electronic device of claim 1, wherein the processor is configured to adjust at least one of: a size, color, and font of the at least one text corresponding to the at least one object based on at least one of: a size, position, type, and logging information of the at least one object, and to control the display to display the adjusted text on the display.

6. The electronic device of claim 1, wherein the processor is configured to determine an order of display, on the display, of the at least one text corresponding to the at least one object based on a determined degree of importance and to control the display to sequentially display, on the display, the at least one text based on the determined order.

7. The electronic device of claim 6, wherein the processor is configured to determine the degree of importance based on at least one of: a size, position, type, and logging information of the at least one object.

8. The electronic device of claim 1, further comprising a camera, wherein the processor is configured to determine an area to which a user's view is directed on the display based on an image obtained through the camera and to control the display to display, on the display, a text corresponding to an object included in the determined area from among the at least one object.

9. The electronic device of claim 1, wherein the processor is configured to determine whether there are texts overlapping each other among the at least one text when displaying the at least one text on the display, and upon determining that there are overlapping texts, to control the display to display only one of the overlapping texts based on a predetermined degree of importance.

10. The electronic device of claim 1, wherein the at least one object includes at least one of: a text, an image, a video, an icon, a link, and an input area.

11. The electronic device of claim 1, wherein the content includes a webpage.

12. A method of controlling an electronic device using speech recognition, the method comprising:
displaying, on a display, content including at least one object and at least one text corresponding to the at least one object, the at least one text obtained based on a resource comprising the content;
determining a first text from among the at least one text corresponding to a voice received using a microphone; and
executing a command corresponding to the received voice on a first object corresponding to the first text from among the at least one object based on at least one command registered to control the at least one object.

13. The method of claim 12, further comprising:
analyzing the resource;
distinguishing the at least one object in the content and determining at least one text corresponding to the at least one object based on a result of the analysis of the resource; and
registering the at least one command to control the at least one object based on the result of the analysis of the resource.

14. The method of claim 12, wherein displaying, on the display, the at least one text corresponding to the at least one object includes determining at least one non-text object from among the at least one object based on the resource and displaying, on the display, the at least one text by making the at least one object correspond to the at least one non-text object.

15. The method of claim 12, further comprising:
determining an object to which to apply a graphical user interface (GUI) from among the at least one object based on a property of the at least one object obtained based on the resource; and
displaying, on the display, a GUI corresponding to the property of the determined object by making the GUI corresponding to the property of the determined object correspond to the determined object.

16. The method of claim 12, wherein displaying, on the display, the at least one text corresponding to the at least one object includes adjusting at least one of: a size, color, and font of the at least one text corresponding to the at least one object based on at least one of: a size, position, type, and logging information of the at least one object and displaying the adjusted text on the display.

17. The method of claim 12, wherein displaying, on the display, the at least one text corresponding to the at least one object includes determining the degree of importance based on at least one of: a size, position, type, and logging information of the at least one object, determining an order of display, on the display, of the at least one text corresponding to the at least one object based on a determined degree of importance, and sequentially displaying, on the display, the at least one text based on the determined order.

18. The method of claim 12, further comprising determining an area to which a user's view is directed on the display based on an image obtained through a camera, wherein displaying, on the display, the at least one text corresponding to the at least one object includes displaying, on the display, a text corresponding to an object included in the determined area from among the at least one object.

19. The method of claim 12, wherein displaying, on the display, the at least one text corresponding to the at least one object includes determining whether there are texts overlapping and displayed among the at least one text and upon determining that there are overlapping texts, displaying only one of the overlapping texts based on a predetermined degree of importance.

20. A non-transitory machine-readable storage medium having recorded thereon a program, which when executed by a processor, causes an electronic device using speech recognition, to perform operations comprising:
displaying, on a display, content including at least one object and at least one text corresponding to the at least one object, the at least one text obtained based on a resource comprising the content;
determining a first text from among the at least one text corresponding to a voice received using a microphone; and
executing a command corresponding to the received voice on a first object corresponding to the first text from among the at least one object based on at least one command registered to control the at least one object.
